(19) United States
(12) Patent Application Publication
(10) Pub. No.: US 2009/0077649 A1
(43) Pub. Date: Mar. 19, 2009

(54) Secure messaging system and method

(75) Inventors: Thomas Wayne Lockhart, Vancouver (CA); Eric Christopher Gold, Vancouver (CA)

Correspondence Address: KLARQUIST SPARKMAN, LLP, 121 SW SALMON STREET, SUITE 1600, PORTLAND, OR, 97204, US

(73) Assignee: Soft Trust, Inc.

(21) Appl. No.: 11/901,048

(22) Filed: Sep. 13, 2007

(51) Int. Cl. G06F 21/00; G06F 15/16

(52) U.S. Cl. 726/14; 709/203

(57) ABSTRACT

A system and method for secure data communication between users when logged on to a central server through a network. The system permits subscribers to the system to create associations with non-subscribers which permits those non-subscribers to access the system to send and receive secure data communication to the subscriber that created the association with the non-subscriber.

This invention relates to secure data messaging by means of a secure messaging server based system accessible by users over a computer network such as the Internet, and more particularly relates to access to such a system by non-subscribing users to both send and receive secure messages.

### BACKGROUND

Electronic mail, also commonly known as email, is a widely used means of communication between various types of communication devices such as computers. Typically, email communication software, such as Microsoft Outlook running in a computer system is used to send, receive and store email messages. Email messages are sent between communication devices, called routers and mail servers by means of one or more computer networks, such as local area networks, wide area networks and/or the Internet.

When a sender's email message intended for a recipient over the Internet leaves the sender's communication device, such as the sender's computer, it first travels through a computer network to the mail server of the sender's organization, eg. employer, or Internet service provider which then transmits the message over the Internet. Email messages travelling through the Internet may go through several intermediate routers before reaching the recipient's communication device. In some cases, the email messages are stored in one or more of those routers and the respective sender's or recipient's mail servers. Internet users have no control over these routers which can be located almost anywhere in the world. Whether stored or not, it is relatively easy for third parties to intercept and read email messages travelling through the Internet. It is therefore important to ensure that confidential email messages and/or confidential email attachments are protected as they travel between the sender and recipient communicating by email when using the Internet. This is especially relevant for professional service firms such as accounting, legal and financial, whom by their very nature, routinely use email to communicate sensitive information with their clients.

There are three primary means of providing more secure email communication over the Internet: end to end desktop email encryption; boundary email encryption; and, secure web based messaging systems.

End to end desktop email encryption is widely recognized as being the most secure method of electronic communication. Email exchanged in this manner can be digitally signed and or encrypted at the sender's desktop and remains that way throughout its journey to the recipient's desktop. End to end desktop email encryption typically requires the use of public key infrastructure in conjunction with the installation of desktop software that supports standard secure email protocols such as S/MIME or PGP which are not supported by all email clients. Every user must install a digital certificate and desktop software. It is better suited for internal communication between employees (within an enterprise) in a homogeneous computer environment. An email sender must know what type of secure email protocol the intended recipients are capable of using before sending them an encrypted message.

Boundary email encryption solutions (also know as email-gateway solutions are generally deployed with hardware or software solutions installed at the boundary of an organization's network, that is, where it connects to a public network. An email message is not secured until it reaches the boundary of the organization. In their simplest form they are used to encrypt all outgoing messages and decrypt any incoming messages. The boundary approach has the main advantage of enabling easier deployment relative to desktop-based solutions and providing policy based security vs. security that is dependent upon individual user behaviour. It is better suited for communication with partners (ie. business to business) as it only works between organizations that have installed secure email gateways. Email on the local area network is not secure.

Secure web based messaging or file transfer/sharing solutions rely on security provided by industry standard secure socket layer SSL/TLS protocols in the delivery of secured messages and file attachments and typically does not involve the use of the standard email protocol, SMTP. Most such solutions use a pull model. Within a pull model, a notification message is sent to the recipient via an email containing a link (ie. a URL) to pull the user back to the web server where a secure inbox is displayed. The recipient can then securely view the message and download file attachments with a common browser using a SSL/TLS connection. This approach has the main advantage of being highly interoperable and easy to use, as it does not require the end user to install any special purpose software or hardware. It is better suited for business to consumer communications. Also, because these solutions bypass the SMTP protocol, they have the freedom to develop additional functionality such as the ability to track messages. The encryption is point to point, that is data is only secure during transmission over the internet between the user's PC and the web server and any data that is stored on the web server may not be encrypted.

Commercial providers of these secure solutions typically have two distinct classes of users: higher class users (herinafter called level two users) and lower class users (hereinafter called level one users). Level two users typically pay for the service (ie. are subscribers) while level one users are typically non-subscribers and do not pay, or do not pay as much, for the service. Normally, these solutions severely reduce the capabilities of the level one users when compared to level two users, so as to induce the level one users to pay to become level two users.

### SUMMARY OF THE INVENTION

Applicant has developed a unique system which provides improvements over how level two users to the system can communicate with level one users and how level one users can communicate with level two users, all using the secure messaging system of the present invention.

A major advantage of the applicant's system is that level one users enjoy all communication capabilities as compared with level two user to the system. The only exceptions being an inability to use the system for secure communication with other level one users and with level two users who do not “associate” themselves with the level one user. Impediments to level two user communication with level one users is at a minimum which increases the opportunities for secure message communication between level two users and level one users using the applicant's secure messaging system. Otherwise, level two users could become disenchanted with applicant's secure messaging system and reluctant to carry on as level two users.

Applicant's system provides a secure web mail system which can be securely accessed by users through an SSL/TLS protocol and which permits level one users to send and receive messages to level two users of the system, without having to subscribe to the system.

In one aspect of the invention, a server computer to facilitate data communications between client computers representing level two users and level one users, in data communication with the server computer over a computer network, includes level two user verification means for verifying the identity of a level two user accessing the server computer from a client computer used by the level two user; means for receiving an association from the client computer used by the level two user verified by the level two user verification means, over the network, the association identifying a level one user with whom the level two user may communicate by means of the server computer; means for storing the association; level one user verification means for verifying the identity of the level one user of the association when accessing the server computer from a client computer used by the level one user; means for providing the level one user verified by the level one user verification means with access to the server computer to send and receive data communications by means of the server computer to and from the level two user who associated that level one user; and means for restricting associations between level one users and other level one users; wherein at least level two users must pay to send and receive data communications by means of the server computer and wherein the amount payable on behalf of level two users is higher as compared to any amount payable on behalf of level one users in order to send and receive data communications by means of the server computer.

In another aspect of the invention the level two user may access the server computer to send and receive data communications by means of the server computer to and from other level two users and the level one user does not obtain access to the server computer to send and receive data communications by means of the server computer to and from level two users with whom the level one user is not associated by means of an association.

In a further aspect the level two user accesses the server computer as a subscriber and the level one user accesses the server computer as a non-subscriber.

In another aspect the level one user pays a nominal amount as consideration to obtain access the server computer to send and receive data communications by means of the server computer to and from level two users with whom the level one user is associated by means of an association.

In yet another aspect of the invention the level one user pays nothing as consideration to obtain access the server computer to send and receive data communications by means of the server computer to and from level two users with whom the level one user is associated by means of an association.

In a further aspect of the invention the level one user provides non-monetary consideration as consideration to obtain access the server computer to send and receive data communications by means of the server computer to and from level two users with whom the level one user is associated by means of an association.

In another aspect of the invention the data communication between the level two user and the server computer and the level one user and the server computer each occurs through separate secure network access between the client computer accessible by the level two user and the server computer and the client computer accessible by the level one user and the server computer. The secure network access may be by a Secure Socket Layer or Transport Layer Security connection over the Internet.

In a further aspect of the invention the means for providing and the means for restricting comprises a derived contact list containing only those level two users who have associated that level one user and wherein the level one user may only communicate with the level two users in the level one user's derived contact list in order to send and receive data communications by means of the server computer.

In an alternate aspect of the invention a computer implemented method for communications between client computers representing level two users and level one users, in data communication with the server computer over a computer network, including the steps of: (a) verifying the identity of a level two user accessing the server computer from a client computer accessed by the level two user; (b) receiving an association from the client computer accessed by the level two user verified at step (a), over the network, the association identifying a level one user with whom the level two user may communicate by means of the server computer; (c) storing the association; (d) verifying the identity of the level one user of the association when accessing the server computer from a client computer accessed by the level one user; (e) providing the level one user verified at step (d) with computer access to the server computer to send and receive data communications by means of the server computer to and from the level two user who associated that level one user; (f) restricting associations between level one users and other level one users; and (g) obtaining payment from at least level two users to send and receive communications by means of the server computer wherein the amount payable on behalf of level two users is higher as compared to any amount payable on behalf of level one users in order to send and receive communications by means of the server computer.

Alternatively, if more than one level two user undertakes step (b) above for the same level one user, permitting the level one user to send simultaneous data communications to all such level two users by means of the server computer.

As a further alternative, after step (b) above, determining whether the level one user to be associated by the level two user is an existing level two user and only if not, proceeding to step (c).

As an alternative, at step (e) above, also providing the level one user verified at step (d) with computer access to the server computer to send data communications by means of the server computer in response to a specific data communication received from the level two user who associated that level one user, to all other recipients of that data communication who are level two users.

As another alternative, at step (d) above verifying the identity of the level one user comprises only requiring the level one user to provide an email address and a password.

As an alternative, at step (d) above, verifying the identity of the level one user comprises obtaining a user name and password from the level two user who associated that level one user and requiring the level one user to use that user name and password to permit the level one user's initial access to the server computer to send data communications by means of the server computer.

As another alternative, a plurality of level two users comprise the level two user and the payment at step (g) is for all level two users of the plurality.

### DESCRIPTION OF THE DRAWINGS

FIG. 1 depicts schematically a system for communicating data messages between users of the system;

FIG. 2 is a flowchart depicting a method for verifying the identity of a user;

FIG. 3 depicts schematically certain details of a user record and a contact record;

FIG. 4 is a flowchart depicting a method for adding a contact of a level two user;

FIG. 5 is a flowchart depicting a method for sending a new data message;

FIG. 6 is a flowchart depicting a method for receiving a data message; and

FIG. 7 depicts schematically message communication possibilities between level one and level two users of the secure messaging system.

### DETAILED DESCRIPTION OF A PREFERRED EMBODIMENT

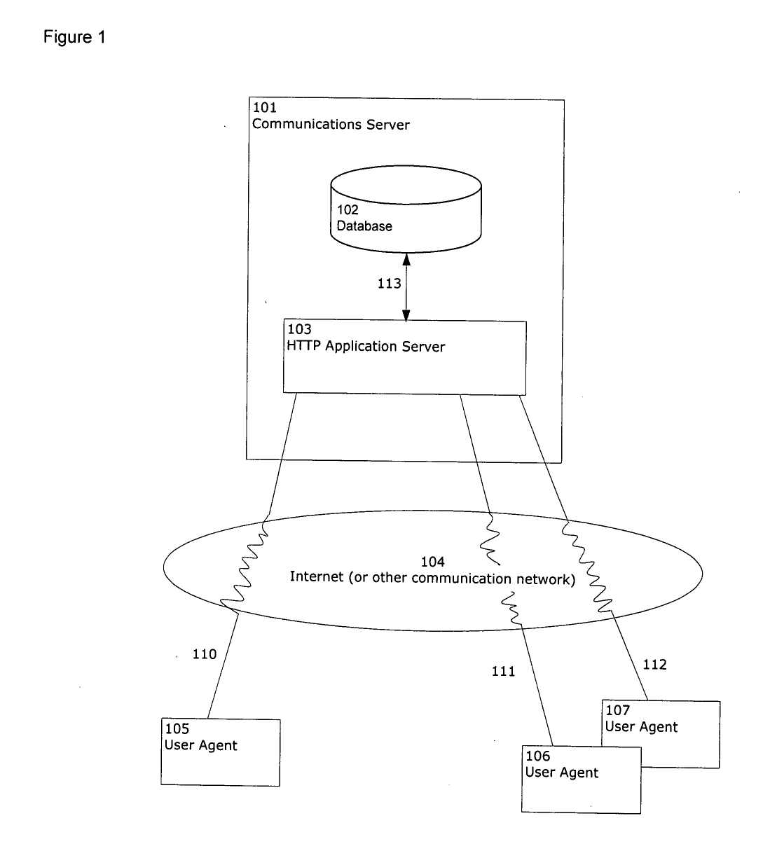

The computer implemented system and method of providing data message delivery between subscribers to the data messaging system, ie. level two users, and level one users of that system using a computer network (sometimes referred to herein as the “data messaging system”) will be discussed initially with reference to FIG. 1. Data messages can include text messages (including emails) both with or without attachments as well as future means of electronic communication that may be used to transmit information electronically.

Communications Server 101 is resident in a secure location controlled by the administrator of the secure data messaging system. Communications Server 101 contains a Database 102 stored in the non-volatile memory of Communications Server 101. Database 102 contains stored information about users, data messages and file attachments, contact lists, association information and other information desired by the administrator in order to provide the appropriate user functionality to subscribers and level one users of the system.

It should be understood that the term “level two user” is used herein as a broader term encompassing the term “subscriber”, but also a more general term to identify any user provided with more comprehensive association privileges to third parties to send and receive data communication securely using the subject system and method, as compared to level one users. The term “level one user” is used herein as a broader term encompassing the term “non-subscriber” as well as generally describing a user with more limited association privileges to third parties to send and receive data communication securely using the subject system and method. More particularly, level one users cannot associate themselves with other level one users to send and receive data communication securely using the subject system and method. Nor can level one users associate themselves with level two users who have not associated themselves with that level one user, to send and receive data communication securely using the subject system and method. In a preferred embodiment level two users may associate themselves with any recipient capable of accessing the server of the system and method, whether level one users (including non-subscribers) or level two users (including other subscribers) to send and receive data messages using the subject system and method.

As used herein the term “associate” and variations means the ability of one user to connect themselves with another user to enable each user to communicate with the other connected user to send and receive data communication securely using the subject system and method and the term “association” means the information identifying two associated users.

Communications Server 101 also includes HTTP (HyperText Transfer Protocol) Application Server 103 which services requests received over the Internet, primarily from users logged in to the data messaging system. Communications Server 101 is connected to a communication network such as the Internet 104 to send and receive communications between users. User Agents 105, 106 and 107 represent user agents, such as web browser software located on client computers for example Mozilla Firefox software, which permit users to access Internet 104 by means of a communication device, such as a computer. In order to utilize the data messaging system, User Agents 105, 106 and 107 connect to the Communications Server 101 through the Internet 104 using the TCP/IP protocols (and possibly also the SSL or TLS protocols) to provide a (possibly secure) connection 110, 111, and 112 between HTTP Application Server 103 and respective User Agents 105, 106 and 107. Users must enter a user name and pass phrase which is matched with the user name and pass phrase contained in Database 102, in order to access their user defined information located in database 102. The user defined information may include stored and possibly encrypted data messages, both read and unread, and contact information of third parties associated with that user. The contact information contains email addresses of those recipients with whom a subscriber or level two user has defined an association through Communications Server 101 to another user, whether a level two user or level one user, as described below.

Preferably, contact information associated with a particular user is maintained in a database as a part of Database 102 by means of a database contact record for each contact. A particular user's contact list may be separately stored and retrieved as needed or it may be generated dynamically each time a user accesses the system. In either manner, a contact list of a particular user, whether a level two user or a level one user, is provided to the user for use in creating and dispatching data messages using the data messaging system. For example the user's contact list may be displayed when the user initiates a new message, with the display of a new blank data message to be completed.

It is important to note that data transmissions between User Agents 105, 106 and 107 may be sent to and from each user through a secure conduit via the Internet using the SSL/TLS protocol. The use of this standard security protocol is built into web browser technology and is activated without any user involvement. It is automatically engaged for secure transmission of data when a user accesses the web site of Communications Server 101 in a conventional manner. This should be compared to the unsecured manner in which traditional non-secure email travels over the Internet, travelling through several Internet routers and thereby freely available to be stored and read at any point along that portion of the Internet through which that email travels. A secure data messaging system based on this secure web server model provides significantly enhanced security for sending and receiving data messages, as compared to the unsecured traditional manner in which email is sent over the Internet.

Data message communication using the subject data messaging system is sent and received by users without any necessity for encrypting the content of the data messages given that the sending and receiving of data between Communications Server 101 of the data messaging system and the client (User Agents 105, 106, and 107) is undertaken through a secure SSL/TLS protocol socket or conduit which is built in as a part of Internet browser technology.

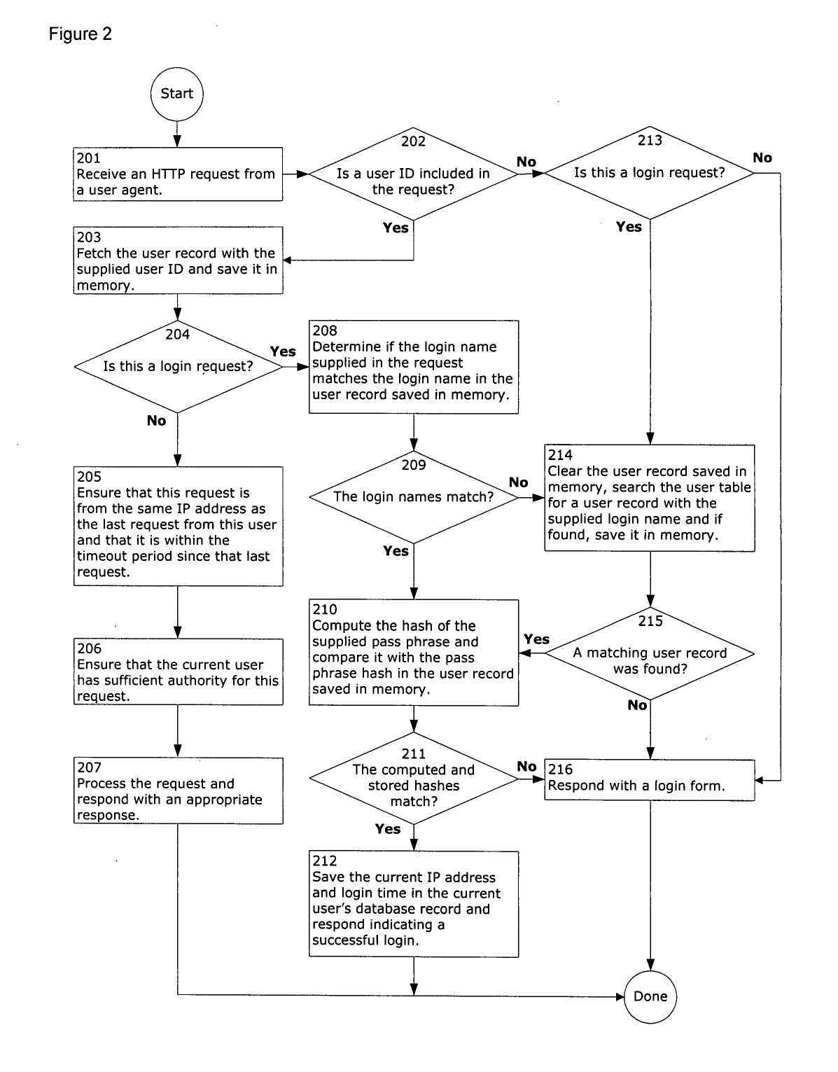

FIG. 2 is a flowchart depicting a method for verifying the identity of a user.

The HTTP protocol is a pure request-response protocol, where each request and resulting response is a transaction. Whenever a user wishes to do anything using the data messaging system, they must use their User Agent 105 to send an HTTP request to the HTTP Application Server 103, which must verify the identity of the requesting user for every request received. Note that all steps of this method are executed by the HTTP Application Server 103 (FIG. 1).

At step 201, the HTTP Application Server 103 receives an HTTP request from a User Agent 105, usually on behalf of a particular user of the data messaging system. At step 202, the server 103 determines if the received HTTP request contains the unique user ID of the requesting user. If it does, the server 103 fetches the User Record 301 whose UserID 302 matches that user ID at step 203 and saves that User Record 301 in memory. At step 204 the server determines if this HTTP request is a login request and if not, proceeds to step 205.

At step 205, the server compares the IP (Internet Protocol) address of the requesting User Agent 105 with the LastIpAddress 305 field of the User Record 301 just saved in memory, which is the IP address of the last accepted transaction from the requesting user. Also at step 205 the server compares the current time with the LastTxnTime 306 field of the User Record 301 stored in memory, which is the time of the last accepted transaction from the current user. If either the IP address is not the same, or the time since the last transaction is greater than some predetermined value (such as 15 minutes or other configured amount), the server rejects the transaction and responds to the user-agent with a login form. If however the IP address and time match, then the server updates LastTxnTime 306 field of the User Record 301 stored in memory and saves it for possible use in the future to verify the identity of this user.

It should be noted that alternate embodiments of step 205 are possible, where a unique identifier of the User Agent 105 is other than its IP address. This could be the host identifier of a communication network other than the Internet, or it could be a random number previously assigned to this user's current session by the HTTP Application Server 103, or other appropriate identifier of User Agent 105.

Assuming that this transaction passed the test of step 205, the server proceeds to step 206 and verifies that the user's authority level, as identified by the UserType 307 field of the User Record 301 stored in memory, is sufficient to execute the current type of transaction.

This step 206 is important to the current invention, as it is one of the possible means that a level one user is prevented from associating themselves with certain other users. In the preferred embodiment, the transaction for creating associations requires an authority level that level one users do not have, thus the HTTP Application Server 103 server will reject any attempt by a level one user to create such an association and it will return an error response.

Assuming that the current transaction passed the authority level test of step 206, the server proceeds to step 207 to process the request and return a response. Several different transaction types are possible at this point and relevant ones are described in more detail with respect to the following figures. It should be noted that there are other possible circumstances that will cause the server to reject a transaction and return an error response during this subsequent processing of the transactions. It should also be noted that in possible alternate, but not the most preferred, embodiments the server might not return a response at all when a transaction is rejected.

The foregoing discussion of FIG. 2 described the normal, “success case”, for the processing of a transaction. There are several other situations with respect to verifying the identity of a user that must be taken into consideration.

Returning to step 202, if the server determined that no user ID is included in the transaction request, then the server proceeds to step 213 to determine if this is a login request. If at step 213, the server determines that this is not a login request, the server proceeds to step 216 and responds with a login form. If however at step 213 the server determines this HTTP request is a login request, then the server proceeds to step 214.

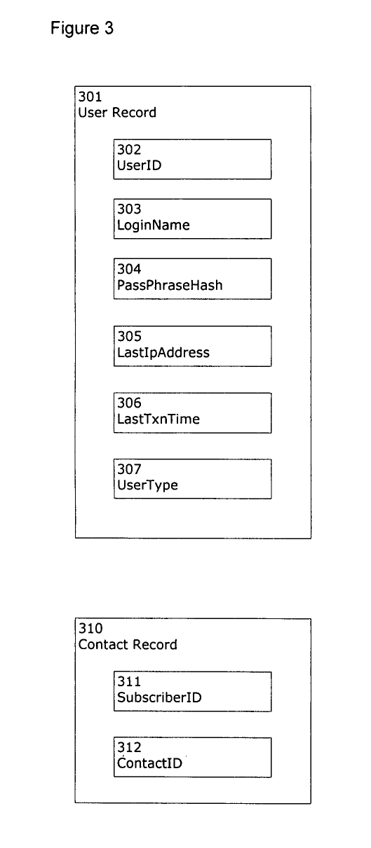

At step 214, the server clears any user record related to the current HTTP request, which the server may have previously saved in memory, and searches its database for a User Record 301 with a LoginName 303 field (FIG. 3) that matches the login name included in this HTTP request, which has been determined to be a login request, and if found, saves it in memory. The server then proceeds to step 215 to determine if such a User Record 301 was found. If not, the server proceeds to step 216 and responds with a login form.

If at step 215 the server determines that a matching User Record 301 was found, the server proceeds to step 210 to verify the pass phrase supplied in the login request. In the preferred embodiment, the server verifies the supplied pass phrase by computing a hash of the pass phrase and login name and comparing it with the PassPhraseHash 304 field of the User Record 301 saved in memory, which the server previously computed and saved in the User Record 301 when this user's LoginName 303 or pass phrase where last changed. Computing a hash can be done by any of numerous well known techniques. One such is to compute the CRC32 (32 bit Cyclical Redundancy Code) as published on the Internet as IETF RFC 3309, of the concatenated normalized login name and pass phrase. Other alternate embodiments are also possible, including saving and comparing the pass phrase directly (not preferred), or any other technique known in the art to verify the credentials (ie. login name and pass phrase) of the user attempting to log in.

If at step 211, the server determines that the login name and pass phrase included in this HTTP request, which is a login request, do not match the information in the User Record 301 saved in memory, the server proceeds to step 216 and responds with a login form as described previously. Note that in the preferred embodiment, if the server detects such a login failure, it delays for a period of a few seconds, to impede automated attempts to login to the HTTP Application Server 103.

If at step 211, the server determines that the login name and pass phrase included in this login request are correct, then the server proceeds to step 212, where it saves the IP address of the current transaction in the LastIpAddress 305 field and the current time in LastTxnTime 306 field of the User Record 301 saved in memory and also saves that User Record 301 in the database for possible use for the validation of future transactions. At this point, the server makes an appropriate response to this login request, such as displaying a list of the messages currently available to this user, or otherwise indicating a successful login.

Returning to step 204, if at that point the server determined that the current HTTP request is a login request, then it proceeds to step 208 and compares the LoginName 303 field of the User Record 301 saved in memory with the login name included in this login transaction and proceeds to step 209. If at step 209, the server determines that the login names are different, then the user record saved in memory is not correct, so the server proceeds to step 214 to clear it and search the database for a User Record 301 with the supplied login name, as previously discussed. If at step 209, the login names match, the server proceeds to step 210 to continue processing this login request as described above.

Note that alternate embodiments might use different methods to verify the identity of a user without departing from the scope of this invention.

FIG. 3 depicts schematically certain details of preferred database record types, namely user record 301 and contact record 310, which reside in the database 102 of FIG. 1.

A User Record 301 contains at least 6 fields: a UserID 302, a LoginName 303, a PassPhraseHash 304, a LastIpAddress 305, a LastTxnTime 306; and a UserType 307. There is one instance of this User Record 301 for each user account of the data messaging system and it contains relevant information about the user account it represents.

The UserID 302 field is a unique identification number for the user account and is an index into the user account table where specific information about the user account is stored.

The LoginName 303 field is the unique name for the user account. In the preferred embodiment this is the normalized email address of the user.

The PassPhraseHash 304 field is a number computed from the LoginName 303 field and the pass phrase for the user account.

The LastIpAddress 305 is a number identifying the IP address last used by a User Agent 105 on behalf of this user account.

The LastTxnTime 306 is a number identifying the time of the last verified request submitted on behalf of this user account.

The UserType 307 is a number that identifies the user type, which at a minimum can be used to determine if this user account is for a level one user or a level two user.

A Contact Record 310 contains at least two fields; a SubscriberID 311 and a ContactID 312. It defines an association between the level two user identified by SubscriberID 311 and the level one or level two user identified by ContactID 312. The contact records are used to determine the contact lists for both level one users and level two users.

The SubscriberID 311 field contains a user ID of a level two user of the system.

The ContactID 312 field contains the user ID of either a level one or level two user of the system associated with the particular level two user identified by SubscriberID 311.

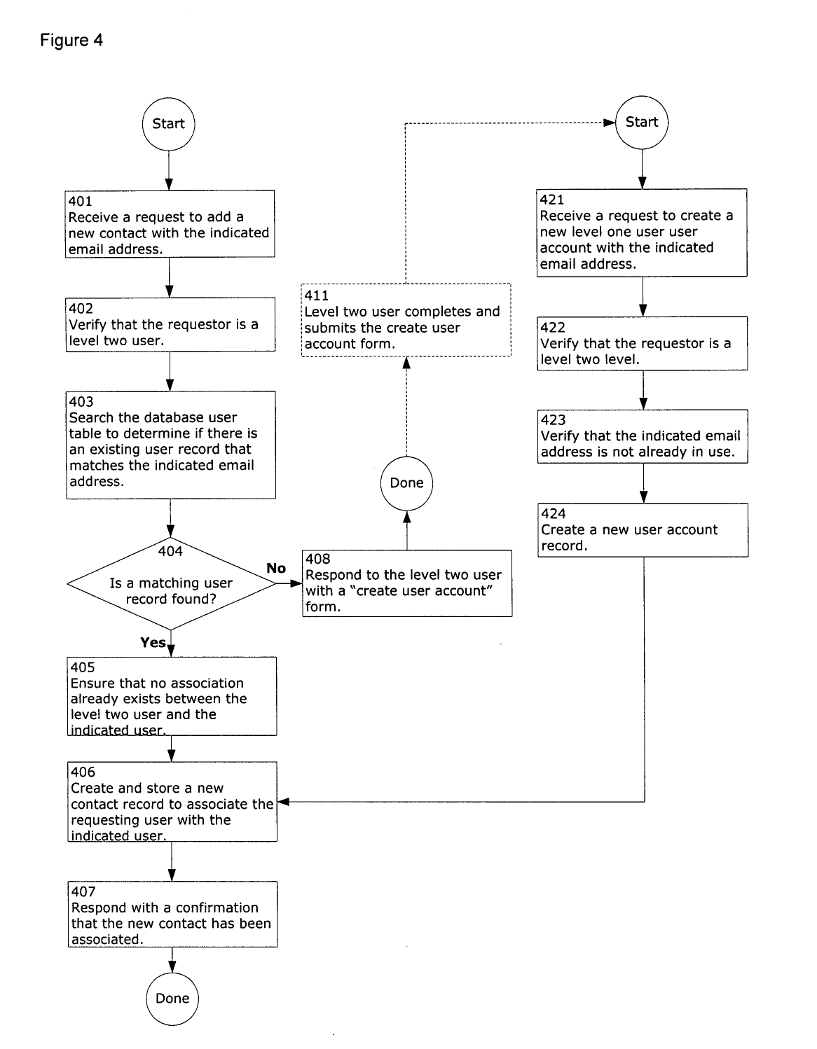

FIG. 4 is a flowchart depicting a method for adding a contact of a level two user, the contact to be associated with that level two user, all the steps of which, except for step 411, are performed by the HTTP Application Server 103.

At step 401, the server receives and authenticates, with a method such a depicted in FIG. 2, an HTTP request from a user's User Agent 105 to add a new contact for the requesting user. In other words, the server receives a request to create an association between the requesting user and the user identified by email address in the current request.

At step 402, the server verifies that the requesting user, ie. the requester, is a level two user. Note that this step is actually a duplicate of step 206. In the preferred embodiment, all transactions are verified to ensure that the requesting user has sufficient authority to execute the transaction. If the requestor is not a level two user the server returns an error response. If however the user is a level two user, the server proceeds to step 403.

At step 403 the server searches the User Records 301 in the database to determine if there is a User Record 301 with a LoginName 303 field that matches the email address specified in this request, that is if the system already includes the user requested to be associated with the requestor. If at step 404, a matching user record was found, the server proceeds to step 405 to ensure that a Contact Record 310 associating this level two user and the user found in step 403 does not yet exist, returning an error response if it does and proceeding to step 406 to create it if no such record exists. The new Contact Record 310 created in step 406 contains the requesting user's user ID as the SubscriberID 311 and the UserID 302 field of the User Record 301 found in step 403 as the ContactID. Finally, after successful completion of step 406, the server proceeds to step 407 to respond to the requesting user's User Agent 105, indicating that the requested association has been created.

Returning to step 404, if no matching User Record 301 was found, the server proceeds to step 408 and responds with a form that the user may use to request the creation of a new user account for the user requested to be associated with the requester.

At step 411, the user may (or may not) complete and submit the “create user account” form responded by the server in step 408. If the user does so, then the server will at step 421 receive and authenticate a request to create a new level one user account with the indicated email address of the user requested to be associated with the requestor as the LoginName 303 field (and possibly other characteristics). At step 422 the server verifies that the requesting user is a level two user, and proceeds to step 423 to verify that the indicated email address is not in use. If there were any problems with these verifications, the server responds with an error response, otherwise it proceeds to step 424 and creates and saves the new User Record 301. Then the server proceeds to step 406 to create and store the association as a Contact Record 310 as previously described and respond with a confirmation to the requestor at step 407.

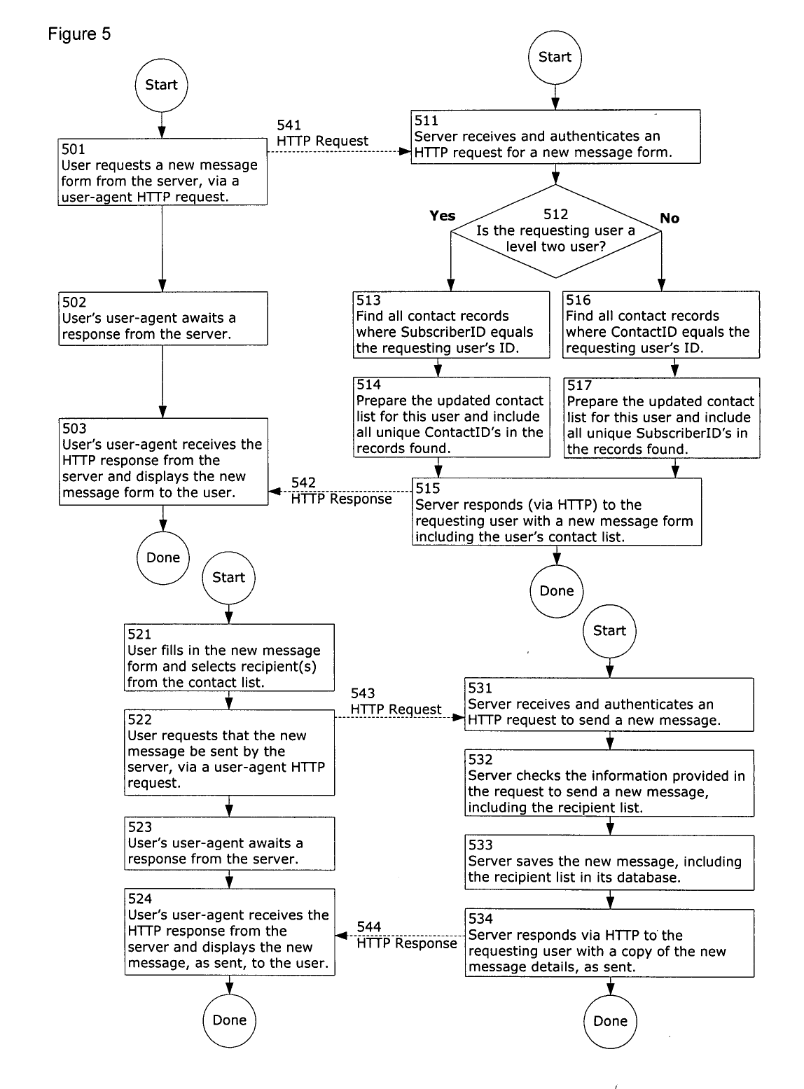

FIG. 5 is a set of four flowcharts depicting a method for sending a new data message. The entire process has two phases: first at steps 501 through 503, the user, via their User Agent 105, requests a new message form, which the HTTP Application Server 103 responds to in steps 511 through 517; and secondly at steps 521 through 524, the user prepares the new message and requests, via their User Agent 105, that it be sent by the HTTP Application Server 103, which the HTTP Application Server 103 responds to in steps 531 through 534.

The dotted lines 541 through 544 represent the requests and responses, rather than flow of control and are for clarity only. HTTP Request 541 represents the request for a new message form and HTTP Response 542 represents the response containing the new message form. HTTP Request 543 represents the request to send a data message and the HTTP Response 544 represents the response to that request.

The entire process begins at step 501 where the user requests a new message form from the server. This may be done by clicking on a link on the previous response sent to the user's User Agent 105. In the preferred embodiment, when a user is logged in, all responses to the User Agent 105 contain such a link. At step 502, the User Agent 105 waits for a response to this request and at step 503 it receives HTTP Response 542 and displays it to the user. Note that in the preferred embodiment, this new message form contains a list of users associated with the requesting user from which the requesting user may select one or more recipients of the new message, that is, the new message form contains a copy of the requesting users's contact list.

Returning to step 511, which occurs temporally after step 501 and before step 503, the server receives and authenticates the request for a new message form submitted by the requesting user and proceeds to step 512.

If at step 512 the server determines that the requesting user is a level two user, the server proceeds to step 513 where it searches its database to find all Contact Records 310, where the SubscriberID 311 matches the requestor's user ID. The server then proceeds at step 514 to prepare a contact list for the requesting user, which consists of all users whose user IDs match the ContactID 312 of the Contact Records 310 found in step 513. The server then proceeds to step 515.

If however, at step 512 the server determines that the requesting user is not a level two user, the server proceeds to step 516 where it searches its database to find all Contact Records 310, where the ContactID 312 matches the requestor's user ID. The server then proceeds at step 517 to prepare a contact list for the requesting user, which consists of all users whose user IDs match the SubscriberID 311 of the Contact Records 310 found in step 516. The server then proceeds to step 515.

Finally, at step 515 the server responds to the user with a new message form containing the contact list just prepared in either step 514 if the requesting user is a level two user, or step 517 if not.

It should be noted that alternate embodiments may either add additional users to these contacts lists or remove some users from the lists. Additions might include: the system administrator, or all level two users belonging to the same company, or users matching some other useful criteria. Users removed from the list might include those whose subscriptions have expired or whose ability to receive messages using the data messaging system have otherwise been disabled.

Continuing to phase two of the message sending process, at step 521, the user fills in the new message form, which requires both the provision of the message content as well as the selection of one or more recipients from the contact list included in the form as previously described. The user then proceeds to step 522 to request, via its User Agent 105, that the server, HTTP Application Server 103, sends the message entered in the form. This is done, by clicking a link or button on the form, or some similar mechanism. At this point the User Agent 105 sends the HTTP Request 543 to the server and proceeds to step 523 to await the response from the server. Upon receipt of the response from the server, the User Agent 105 proceeds to step 524 to display HTTP Response 544 to the user.

At step 531, which occurs temporally after step 522 and before step 523, the HTTP Application Server 103 receives and authenticates, as previously described, the HTTP Request 543 to send a new message. Proceeding to step 532, the server checks the information in the requested message, in particular, validating that either the sender or at least one recipient is a level two user. If there were any problems with either step 531 or 532, the server responds with an error response, otherwise it proceeds to step 533 where it saves in its database or otherwise all required information about the message to effect its eventual presentation to the recipients. This required information would include, at a minimum, the content of the message and the list of intended recipients. Finally, the server proceeds to step 534 where it responds with HTTP Response 544 to the user indicating that the message was sent. It should be noted that there are numerous forms this response might take, from a simple status response to a copy of the message as sent, the latter of which is the preferred embodiment.

It should be noted that an important feature of the current invention is that level one users are restricted from associating with or communicating with other level one users. The preferred embodiment described above contains two such mechanisms, either of which are sufficient to effect such restriction. First, the mechanism for creating the contact list contained in the new message form precludes the possibility of a level one user being on the contact list of another level one user, which in combination with the mechanism for selecting recipients restrict the ability for a level one user to communicate with other level one users. Second, the validation of a request to send a new message ensures that at least one level two user must be in the set of recipients of all messages sent by level one users, which also restricts the ability of level one users to associate and communicate with other level one users. It will be obvious to those skilled in the art that there are other ways to restrict the ability of level one users to associate and communicate with each other.

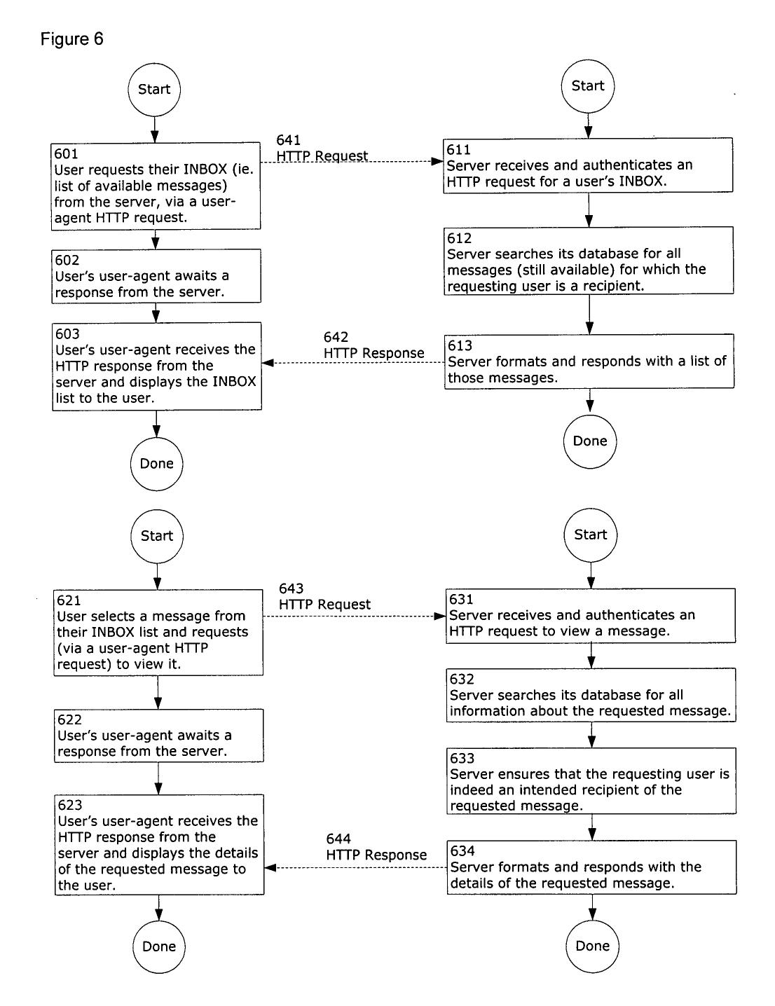

FIG. 6 is also a set of four flowcharts depicting a method for receiving a data message, thus completing the entire process of communication between two users. This “receiving a message” process also has two phases: first at steps 601 through 603, the user, via their User Agent 105, requests a list of all messages available to them, also known as their INBOX, which the HTTP Application Server 103 responds to in steps 611 through 613; and secondly at steps 621 through 623 the user selects an available message to receive and requests via their User Agent 105, that it be sent to them by the HTTP Application Server 103, which the HTTP Application Server 103 responds to in steps 631 through 634.

The dotted lines 641 through 644 represent the requests and responses, rather than flow of control and are for clarity only. HTTP Request 641 represents the request for the INBOX list and HTTP Response 642 represents the response containing that list. HTTP Request 643 represents the request to receive a particular data message and the HTTP Response 644 represents the response to that request.

It should be noted that unlike the two phases required for sending a message, the process for receiving a message may include only the second phase: the request to receive a particular message and the response containing the message. In the preferred embodiment, this is accomplished by sending the recipient a normal email message with a pre-encoded HTTP request that includes the identification of the particularly message. By submitting that request contained in the email, the recipient may bypass the first phase of requesting their INBOX list. If the requesting user is logged in at the time of submitting said request for a particular data message the data message is responded immediately, otherwise the server responds with a login form and after said login form is successfully submitted, the server responds with the particular data message requested, rather than the normal INBOX response to a successful login. This variation, while it is convenient for the users of the data messaging system and this is included in the preferred embodiment, it is not a mandatory feature and may be omitted. Also in the preferred embodiment, the first phase of requesting the INBOX list may be avoided, as the HTTP Application Server 103 may respond with the INBOX list without an explicit request to do so, such as for example in response to a successful login request.

The process of requesting an INBOX list begins at step 601, where the user, via their User Agent 105, sends HTTP Request 641 to the HTTP Application Server 103 for said INBOX list. This may be done by the user clicking on the INBOX link of a previous response from the server. In the preferred embodiment, most responses from the HTTP Application server contain such a link. The User Agent 105 then proceeds to step 602 where it waits for a response from the server. Upon receipt of the response, the User Agent 105 proceeds to step 603 to display HTTP Response 642, which contains the INBOX list, to the user.

At step 611, which occurs temporally after step 601 and before step 603, the HTTP Application Server 103 receives and authenticates HTTP Request 641 as previously described. Proceeding to step 612, the server searches its database to find all messages still available for which the requesting user is a recipient. The server then proceeds to step 613 to format the INBOX list and respond with HTTP Response 642 to the user's User Agent 105.

The process to receive a message begins at step 621 where the user selects a message from their INBOX list and requests via their User Agent 105 to view it. As indicated above, this request could be initiated by the user initiating a request contained in a normal email or otherwise obtained, such as from their User Agent 105 bookmarks. After sending said request, however it was initiated, the User Agent 105 proceeds to step 622 to await HTTP Response 644 from the server. Upon receipt of that response, the User Agent 105 proceeds to step 623 to display HTTP Response 644, which contains the details of the requested message, to the user.

At step 631, which occurs temporally after step 621 and before step 623, the HTTP Application Server 103, receives and authenticates HTTP Request 643 as previously described, and then proceeds to step 632 where the server searches its database for all required information about the requested message. The server then proceeds to step 633 where is verifies that the requestor is indeed an intended recipient of the requested message. If there were any problems so far, the server responds with an error response, otherwise the server proceeds to step 634 to format the requested message and sends HTTP Response 644 containing the message details to the user's User Agent 105.

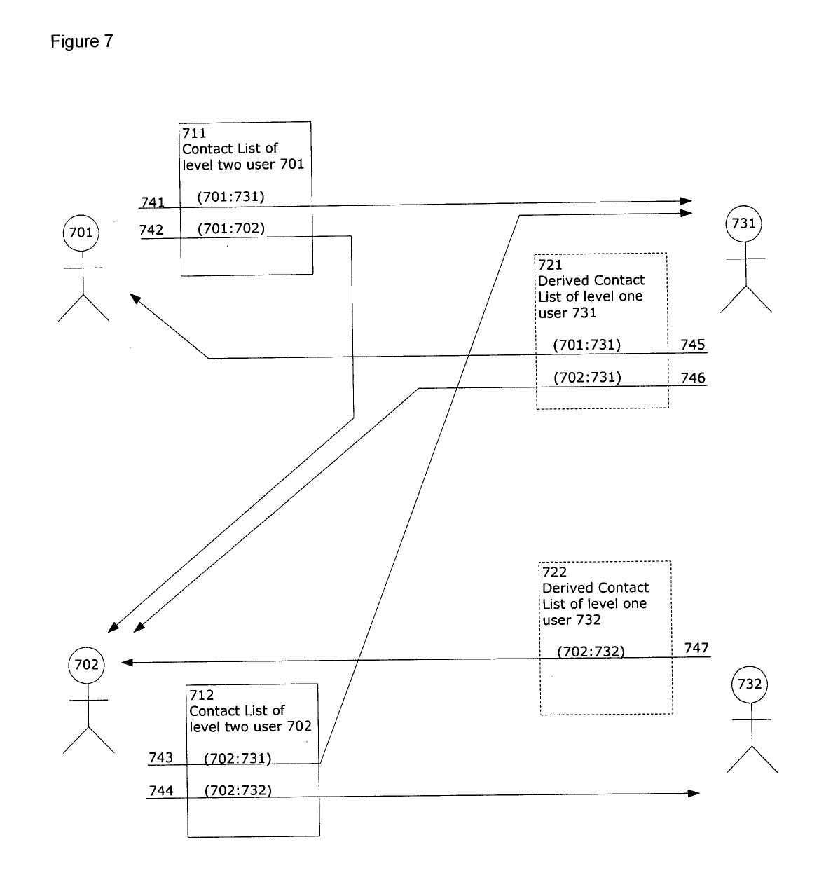

FIG. 7 depicts schematically examples of message communication possibilities between level one and level two users of the secure messaging system and method of the present invention.

Users 701 and 702 are level two users of the system, and as described above have the ability to associate themselves with other users thus creating their contacts lists, Contact List 711 and 712. Users 731 and 732 are level one users of the system and as also described above do not have the ability to associate themselves with other users of the system.

The boxes, Contact List 711 and Contact List 712, represent the contact lists of level two users 701 and 702 respectively. The numbers inside represent associations between two users of the system. These lists contain the set of Contact Records 310 where the SubscriberID field 311 matches the user ID of the level two user whose contact list this is. In the scenario depicted each of the level two users 701 and 702 have previously created two associations each. User 701 had created an association to level one user 731 and another to level two user 702. User 702 had created associations to the two level one users 731 and 732. The reader will realize, that this is only a simple example, and that in a realistic situation each user may have many such associations.

The boxes, Derived Contact List 721 and Derived Contact List 722, represent the derived contacts lists of the level one users 731 and 732 respectively. The numbers inside represent associations between two users of the system. These lists contain the set of Contact Records 310 where the ContactID field 312 matches the user ID of the level one user whose derived contact list this is. Based upon the associations supposed by this example, level one user 731 has two associations in its derived contact list 721, one to level two user 701 and another to level two user 702. Level one user 731 does not initiate or create derived contact list 721. The association between level one user 731 and level two user 701 is created by level two user 701 and the association between level one user 731 and level two user 702 is initiated by level two user 702. Derived contact list 721 is created by the system based on those two associations. Level one user 732 has only a single association in its derived contact list 722, to level two user 702. The association between level one user 732 and level two user 702 is initiated by level two user 702. Derived contact list 722 is created by the system based on that association.

The lines with arrows 741 through 747 represent possible data messages initiated by the user adjacent the numerical references as sender, through Data Messaging Server 101 to the user adjacent the arrow head of that line as the recipient.

Line 741 represents a data message initiated by level two user 701 to level one user 731.

Line 742 represents a data message initiated by level two user 701 to level two user 702.

Line 743 represents a data message initiated by level two user 702 to level one user 731.

Line 744 represents a data message initiated by level two user 702 to level one user 732.

Line 745 represents a data message initiated by level one user 731 to level two user 701.

Line 746 represents a data message initiated by level one user 731 to level two user 702.

Line 747 represents a data message initiated by level one user 732 to level two user 702.

Note that in the preferred embodiment, it is possible for any user of the system, to specify multiple recipients to a single data message they send, as long as those potential recipients are in the sending user's Contact List 211 or Derived Contact List 221. Furthermore, in the preferred embodiment, it is possible for the sender to indicate if the data message is to be sent “blind” or not. If it is sent “blind” then when the data message is displayed to a recipient, the other recipients are not shown. If the message is not sent “blind”, then the recipient is shown a list of all of the recipients.

Also, in the preferred embodiment, is it possible and permitted for a level two user who is the recipient of a data message to send a reply data message to the sender or to any one of the recipients or to the sender and all of the recipients of that data message. Level one user's however can only reply to the sender or to the sender and all of the recipients. If some of those recipients are in the level one user's derived contact list, the level one user may also reply specifically to the level two users in the level one user's derived contact list without having to reply to all.

Having described the embodiments of the invention, modifications will be evident to those skilled in the art without departing from the scope and spirit of the invention as defined in the following claims. Accordingly, the invention is not limited except as by the appended claims.

As will be apparent to those skilled in the art to which the invention is addressed, the present invention may be embodied in forms other than those specifically disclosed above, without departing from the spirit or essential characteristics of the invention. The particular embodiments of the invention described above and the particular details of the processes described are therefore to be considered in all respects as illustrative or exemplary only and not restrictive. Other embodiments could be developed based on known email configurations, or as may in the future be developed. The scope of the present invention is as set forth in the complete disclosure rather than being limited to the examples set forth in the foregoing description. Any and all equivalents are intended to be embraced.

1. A server computer to facilitate data communications between client computers representing level two users and level one users, in data communication with the server computer over a computer network, said server computer comprising:
(a) level two user verification means for verifying the identity of a level two user accessing the server computer from a client computer used by the level two user;
(b) means for receiving an association from the client computer used by the level two user verified by the level two user verification means, over the network, the association identifying a level one user with whom the level two user may communicate by means of the server computer;
(c) means for storing the association;
(d) level one user verification means for verifying the identity of the level one user of the association when accessing the server computer from a client computer used by the level one user;
(e) means for providing the level one user verified by the level one user verification means with access to the server computer to send and receive data communications by means of the server computer to and from the level two user who associated that level one user; and
(f) means for restricting associations between level one users and other level one users;
wherein at least level two users must pay to send and receive data communications by means of the server computer and wherein the amount payable on behalf of level two users is higher as compared to any amount payable on behalf of level one users in order to send and receive data communications by means of the server computer.

2. The server computer of claim 1, wherein the level two user may access the server computer to send and receive data communications by means of the server computer to and from other level two users and wherein the level one user does not obtain access to the server computer to send and receive data communications by means of the server computer to and from level two users with whom the level one user is not associated by means of an association.

3. The server computer of claim 1, wherein the level two user accesses the server computer as a subscriber and the level one user accesses the server computer as a non-subscriber.

4. The server computer of claim 1, wherein the level one user pays a nominal amount as consideration to obtain access the server computer to send and receive data communications by means of the server computer to and from level two users with whom the level one user is associated by means of an association.

5. The server computer of claim 1, wherein the level one user pays nothing as consideration to obtain access the server computer to send and receive data communications by means of the server computer to and from level two users with whom the level one user is associated by means of an association.

6. The server computer of claim 1, wherein the level one user provides non-monetary consideration as consideration to obtain access the server computer to send and receive data communications by means of the server computer to and from level two users with whom the level one user is associated by means of an association.

7. The server computer of claim 1, wherein the data communication between the level two user and the server computer and the level one user and the server computer each occurs through separate secure network access between the client computer accessible by the level two user and the server computer and the client computer accessible by the level one user and the server computer.

8. The server computer of claim 7, wherein the secure network access is by a secure connection over the Internet.

9. The server computer of claim 8, wherein the secure connection is by a Secure Socket Layer or Transport Layer Security connection over the Internet.

10. The server computer of claim 1 wherein the means for restricting at paragraph (f) of claim 1 comprises a derived contact list containing only those level two users who have associated that level one user and wherein the level one user may only initiate communication with the level two users who are in the level one user's derived contact list in order to send and receive data communications by means of the server computer, wherein initiating communication does not include replying to an existing message.

11. A computer implemented method for communications between client computers representing level two users and level one users, in data communication with the server computer over a computer network, said method comprising the steps of:
(a) verifying the identity of a level two user accessing the server computer from a client computer accessed by the level two user;
(b) receiving an association from the client computer accessed by the level two user verified at step (a), over the network, the association identifying a level one user with whom the level two user may communicate by means of the server computer;
(c) storing the association;
(d) verifying the identity of the level one user of the association when accessing the server computer from a client computer accessed by the level one user;
(e) providing the level one user verified at step (d) with computer access to the server computer to send and receive data communications by means of the server computer to and from the level two user who associated that level one user;
(f) restricting associations between level one users and other level one users; and
(g) obtaining payment from at least level two users to send and receive communications by means of the server computer wherein the amount payable on behalf of level two users is higher as compared to any amount payable on behalf of level one users in order to send and receive communications by means of the server computer.

12. The computer implemented method of claim 11, wherein if more than one level two user undertakes step (b) for the same level one user, permitting the level one user to send simultaneous data communications to all such level two users by means of the server computer.

13. The computer implemented method of claim 11, wherein after step (b) determining whether the level one user to be associated by the level two user is an existing level two user and only if not proceeding from step (c) to step (d).

14. The computer implemented method of claim 11, wherein at step (e) also providing the level one user verified at step (d) with computer access to the server computer to send data communications by means of the server computer in response to a specific data communication received from the level two user who associated that level one user, to all other recipients of that data communication who are level two users.

15. The computer implemented method of claim 11, wherein at step (e) also providing the level one user verified at step (d) with computer access to the server computer to send data communications by means of the server computer in response to a specific data communication received from the level two user who associated that level one user, to all other recipients of that data communication.

16. The computer implemented method of claim 11, wherein at step (d) verifying the identity of the level one user comprises only requiring the level one user to provide an email address and a password.

17. The computer implemented method of claim 11, wherein at step (d) verifying the identity of the level one user comprises obtaining a user name and password from the level two user who associated that level one user and requiring the level one user to use that user name and password to permit the level one user's initial access to the server computer to send data communications by means of the server computer.

18. The computer implemented method of claim 11, wherein a plurality of level two users comprise the level two user and wherein the payment at step (g) is for all level two users of the plurality.

19. A server computer to facilitate data communications between client computers representing level two users and level one users, in data communication with the server computer over a computer network, said server computer comprising:
(a) level two user verification means for verifying the identity of a level two user accessing the server computer from a client computer used by the level two user;
(b) means for receiving an association from the client computer used by the level two user verified by the level two user verification means, over the network, the association identifying a level one user with whom the level two user may communicate by means of the server computer;
(c) means for storing the association;
(d) level one user verification means for verifying the identity of the level one user of the association when accessing the server computer from a client computer used by the level one user;
(e) means for providing the level one user verified by the level one user verification means with access to the server computer to send and receive data communications by means of the server computer to and from the level two user who associated that level one user said means comprising a derived contact list containing only the level two user who associated that level one user and any other level two users who have associated that level one user, wherein the level one user may only initiate communication with the level two users who are in the level one user's derived contact list in order to send and receive data communications by means of the server computer, wherein initiating communication does not include replying to an existing message.

20. The server computer of claim 19, wherein at least level two users must provide consideration to send and receive data communications by means of the server computer and wherein the consideration on behalf of level two users is higher as compared to any consideration provided on behalf of level one users in order to send and receive data communications by means of the server computer.
